(19) United States
(12) Patent Application Publication
(10) Pub. No.: US 2005/0018067 A1
(43) Pub. Date: Jan. 27, 2005

(54) Folder type image photographing apparatus

(76) Inventor: Dong-seok Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/838,373

(22) Filed: May 5, 2004

(30) Foreign Application Priority Data
Jul. 25, 2003 (KR) 2003-51665

(51) Int. Cl. H04N 5/222

(52) U.S. Cl. 348/333.06

(57) ABSTRACT

A folder type image photographing apparatus including a main body at which a recording medium is mounted, a display panel disposed at the main body to display a photographed image, and a camera unit coaxially disposed with respect to the display panel. The camera unit can rotate with the display panel, with the camera unit folded onto the display panel, or the camera unit can rotate independently from the display panel, providing a greater degree of control and operation selection.

### CROSS-REFERENCE TO RELATED APPLICATIONS

This application claims priority under 35 U.S.C. §119 to an application entitled “Folder Type Image Photographing Apparatus” filed in the Korean Intellectual Property Office on Jul. 25, 2003 and assigned Serial No. 2003-51665, the entire content of which is incorporated herein by reference.

### BACKGROUND

1. Field of the Invention

The present invention relates to a folder type image photographing apparatus integrating functions of both a digital still camera and a digital camcorder.

2. Description of the Related Art

In conventional applications, a digital still camera (DSC) converts an image entered through a lens into a digital signal and stores it in a recording medium such as a hard disk or a memory card. A photographed image is not recorded on a film, but stored in the recording medium so that the digital image can be directly input to the computer without having to scan the image. To do this, the digital still camera has a high compatibility with a personal computer to allow easy editing and adjustment on the image, as well as easy transmission of the photographed image with respect to an external computer. Further, the digital still camera has a similar structure with a general camera so that it is easy to carry. That is, the digital still camera has a lens, a memory, a signal modulator and a displayer. However, the digital still camera is used primarily to photograph a still image due to restrictions such as a limited capacity of the recording medium that records the image. The digital still camera has a function to photograph a motion image but it is substantially impossible to photograph the motion image for long periods (e.g. hours). Therefore, being inadequate to photograph, record and reproduce the motion image along with a sound, the digital still camera usually is not used to photograph, store and reproduce the motion image. Accordingly, there is another recording/reproducing device such as a camcorder, which records and reproduces an image and a sound of an object being photographed by using the recording medium such as a tape.

The camcorder has a lens, a signal modulator, a deck, and a displayer. The deck records/reproduces the photographed image. The camcorder typically uses a cassette tape as the recording medium, which is loaded in the deck and records the photographed motion image thereon. Also, the camcorder has a microphone and a speaker. With the cassette tape, the camcorder can photograph images for longer periods, for example, more than an hour. Although the camcorder provides a function to photograph the still image, an image quality of the camcorder is inferior to that of the digital still camera. Hence, the camcorder is generally used to photograph the motion image. Further, having more functions and more complicated structure than the digital still camera, the camcorder is generally bulky and high-priced.

In order to photograph the still image as well as the motion image, it is often required to purchase both the digital still camera and the camcorder, as aforementioned. Accordingly, a consumer has to bear the expenses. Further, due to the separate function of the digital still camera and the camcorder, the consumer experiences an inconvenience in carrying both.

Considering the above shortcomings, a so-called ‘DuoCam’ has been disclosed in Korean Patent Application No. 10-2003-1151, the entire content of which is incorporated herein by reference. The DuoCam is an image photographing apparatus which integrates the digital still camera and a digital video camera, and currently, this type of apparatus is widespread. The DuoCam is basically constructed with a main body having a deck, a camera unit rotatably disposed at the main body, and a LCD panel disposed at the main body. The camera unit is provided with lenses for the digital still camera and the video camera at opposite sides to each other, respectively, so as to select a photographing mode by rotating the camera unit.

However, the above image photographing apparatus provides the camera unit and the LCD panel separately. Accordingly, in order to photograph the image, the camera unit has to be placed at a predetermined position and the position of the LCD panel has to be adjusted.

In addition, in rotating the camera unit there may occur an accident, for example, a finger of the user may become caught between the camera unit and the main body.

Accordingly, a need exists for a system and method that integrates the functions and features of both a digital still camera and a digital camcorder to overcome the difficulties presented above.

### SUMMARY OF THE INVENTION

It is, therefore, an object of the present invention to provide a system and method to having a folder type image photographing apparatus integrating functions of both a digital still camera and a digital camcorder.

It is another object of the present invention to provide a system and method for a folder type image photographing apparatus that allows a user to easily select between camera functions and is provided in a compact device.

These and other objects are substantially achieved by providing a folder type image photographing apparatus having a main body at which a recording medium is mounted, a display panel secured with the main body and rotatable about a first axis to display a photographed image, and a camera unit coaxially secured with the display panel and rotatable about the first axis, the camera unit being further rotatable about a second axis to select between a first and second camera portion. The camera unit includes the first camera portion on a first surface to capture motion images, and the second camera portion to capture still images. By rotating the camera unit independent of the display panel about the second axis, the user can easily select between camera portions while viewing the images on the display.

### BRIEF DESCRIPTION OF THE DRAWINGS

The above objects, and other features and advantages of the present invention will become more apparent after a reading of the following detailed description when taken in conjunction with the drawings, in which:

FIGS. 1 to 3 are perspective views showing a folder type image photographing apparatus according to an embodiment of the present invention;

FIG. 4 is a perspective view showing a camera unit of FIG. 1 in a rotated state on a second axis;

FIG. 5A is a partial view showing a locking hook disposed at a display panel of FIG. 1;

FIG. 5B is a partial view showing a locking recess disposed at a camera unit of FIG. 1;

FIG. 6 is a perspective view showing the camera unit received in a main body and being folded onto the display panel; and

FIG. 7 is a perspective view showing the rotated state of the display panel and the camera unit of FIG. 6.

### DETAILED DESCRIPTION OF THE PREFERRED EMBODIMENTS

Hereinafter, a folder type image photographing apparatus according to an embodiment of the present invention is described in detail with reference to the attached drawings.

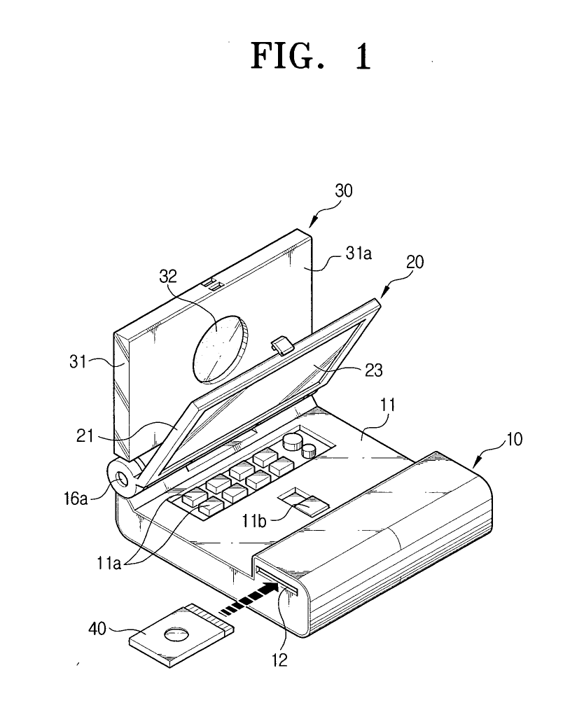

Referring to FIG. 1, the image photographing apparatus includes a main body 10 at which a storage medium is loaded, a display panel 20 disposed to open/close a side of the main body 10, and a camera unit 30 moving together with the display panel 20 while being folded with the display panel 20.

A receiving portion 11 is formed as a depression along an upper side of the main body 10 to receive the display panel 20 therein. The receiving portion 11 is provided with a plurality of manipulating keys 11a to manipulate respective functions of the photographing apparatus. A reference numeral 11b labels and indicates a zoom knob for a zooming operation. At a side of the main body 10, a memory stick mounting portion 12 is formed at which a memory stick 40 is mounted.

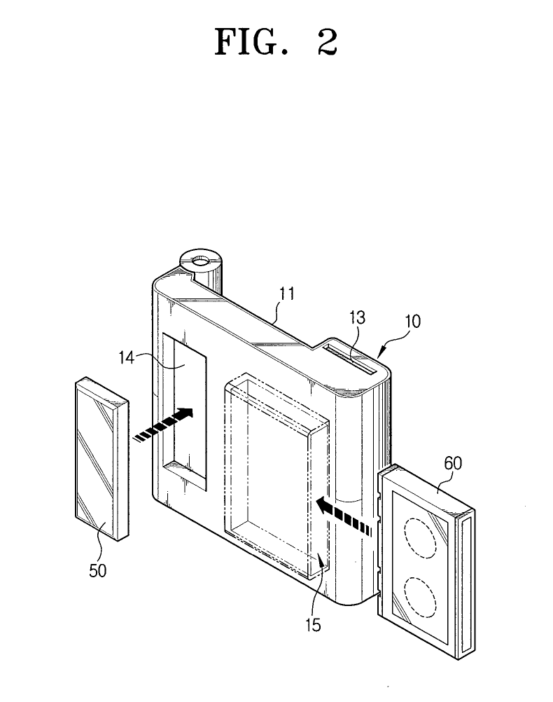

Referring to FIG. 2, a battery mounting portion 14 is formed as a depression at a rear side of the main body 10 to receive a battery 50 therein. Also, a deck 15 is disposed at the rear side of the main body 10 so as to move in and out of the main body 10. At the deck 15, a video tape cassette 60 is mounted to store images including a motion image. The structure of the deck 15 is a technology well known to those skilled in the art, and applied to various products such as a camcorder, and accordingly, the detailed description thereof will be omitted.

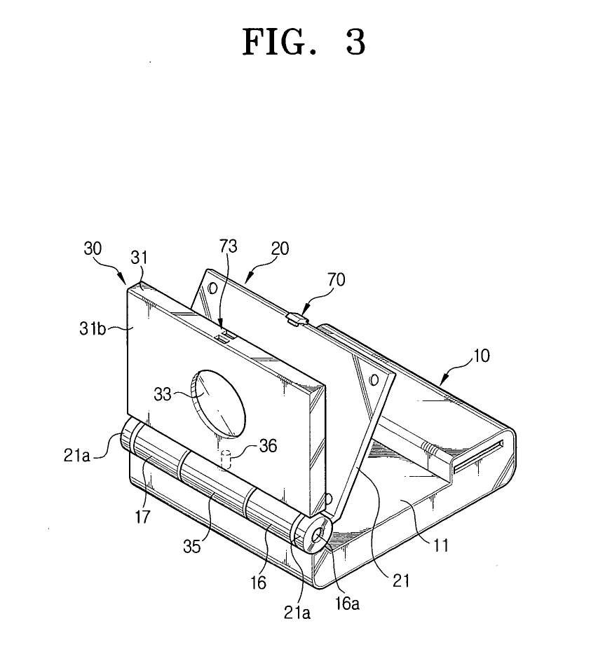

As shown in FIG. 3, a pair of shaft portions 16 and 17 are coaxially fixed at a side of the main body 10. The shaft portions 16 and 17 are fixed at the main body 10 at a predetermine distance from each other at opposite ends of a first shaft 35. The shaft portions 16 and 17 extend axially from the first shaft 35 toward shaft portions 21a, upon which the display panel 20 is rotatably connected. Accordingly, both ends of each shaft portion 16 and 17 are provided with a supporting shaft 16a at which the display panel 20 is rotatably connected.

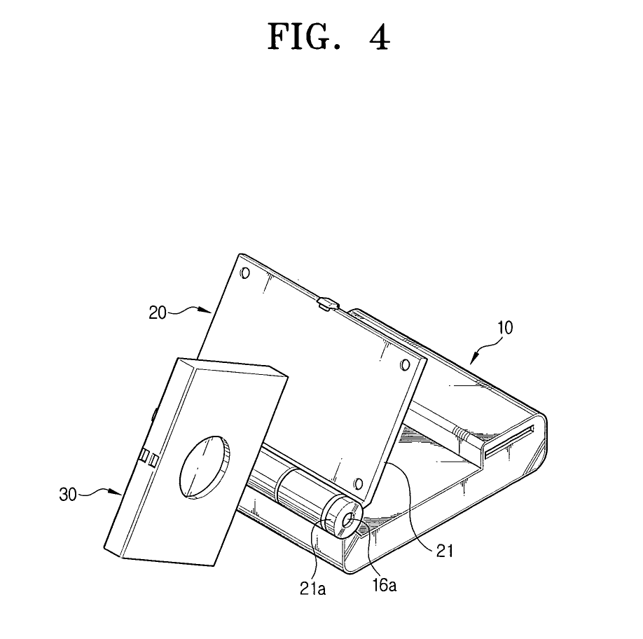

The display panel 20 has a panel body 21 which is supported on the supporting shaft 16a and a LCD 23 disposed at a side of the panel body 21 to display the photographed image. The LCD 23 is disposed opposite the upper side of the main body 10, so as to face to the receiving portion 11. The display panel 20 is positioned to cover the receiving portion 11 or, as shown in FIG. 4, is pivoted to maintain a predetermined angle with respect to the upper side of the main body 10. For this, a pair of shaft portions 21a are disposed at a side of the panel body 21. Hence, the shaft portion 21a is rotatably connected to the supporting shaft 16a.

Referring to FIGS. 1 and 3, the camera unit 30 is disposed so as to rotate along with the display panel 20 while being folded with the display panel 20. The camera unit 30 has a first camera portion 32 disposed to be exposed through a first side 31a of a unit body 31, and a second camera portion 33 disposed to be exposed through a second side 31b. The first camera portion 32 is for the digital video camera which photographs images including the motion image. The second camera portion 33 is for the digital still camera which photographs still images. Each camera portion 32 and 33 is disposed in the unit body with respect to each other such that only one of the camera portions 32 or 33 can be selectively operated at a time.

As shown in FIG. 3, the camera unit 30 has a first shaft 35 coaxially connected to the rotation axis of the display panel 20 and a second shaft 36 disposed in a right angle with respect to the direction of the axis of the first shaft 35. The first shaft 35 is rotatably interposed between the shaft portions 16 and 17 of the main body 10. Accordingly, due to the first shaft 35 and the second shaft 36, the camera unit 30 may rotate with respect to each of shafts 35 and 36 at the right angle to each other. That is, the camera unit 30 can be rotated on the first shaft 35 together with the display panel 20 in the same direction. As shown in FIG. 4, the camera unit 30 can also rotate on the second shaft 36, and accordingly, the camera unit 30 rotates independently from the display panel 20. Therefore, a mode and a direction of photographing can be changed by altering the directions of the camera portions 32 and 33 of the camera unit 30. Herein, since a mechanical structure of the first and the second shafts 35 and 36 are well known, a detailed description thereof is omitted.

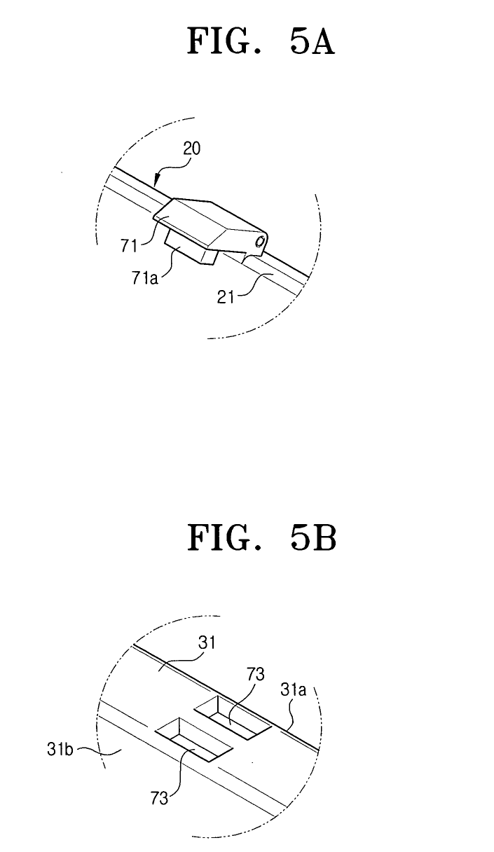

In addition, a locking unit 70 is provided to connect the camera unit 30 and the display panel 20 so as to rotate the camera unit 30 integrally with the display panel 20. The locking unit 70 includes a hook member 71 formed at an outer side of the display panel 20, and a locking recess 73 formed at an outer side of the camera unit 30 to correspond to the hook member 71. The hook member 71, as shown in FIG. 5A, is pivotably disposed at a side of the panel body 21 of the display panel 20. The hook member 71 has a hook projection 71a which can be locked with the locking recess 73.

Preferably, as shown in FIG. 5B, a pair of the locking recesses 73 are formed at an outer side of the camera unit 30. That is, a pair of the locking recesses 73 are formed to lock and connect the camera unit 30 and the display panel 20 according to the rotation of the camera unit 30, i.e., in cases wherein either the first or the second side 31a or 31b faces the display panel and is folded onto the display panel. Each locking recess 73 is located at the same distance from the first and the second side 31a and 31b, respectively.

A method to operate the folder type image photographing apparatus according to the embodiment of the present invention is described below.

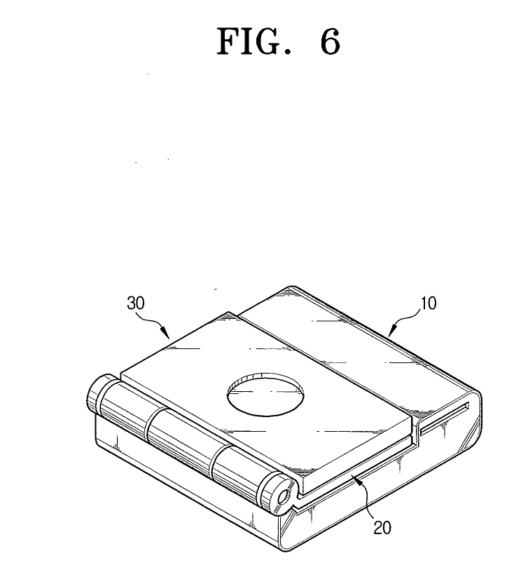

Referring to FIG. 6, the display panel 20 is mounted on the receiving portion 11 at the upper side of the main body 10 and covers an upper portion of the main body 10. Also, the camera unit 30 is folded onto an upper portion of the display panel 20 so as to cover the upper portion of the main body 10 along with the display panel 20.

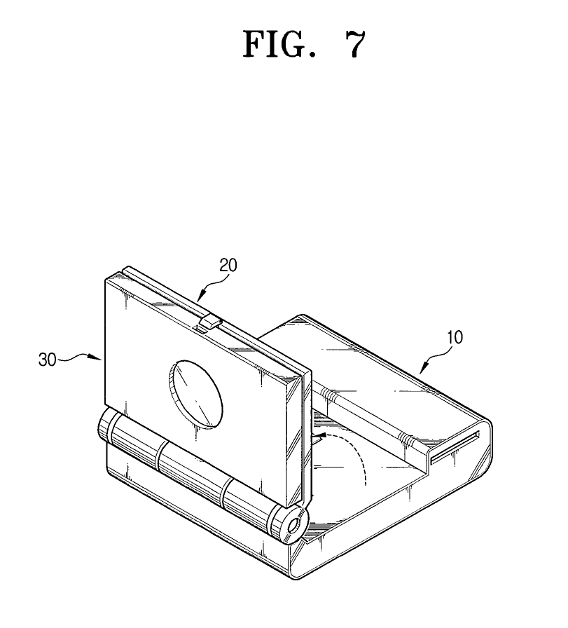

At this time, in order to photograph the image, the display panel 20 and the camera unit 30 are rotated together and unfolded from the upper side of the main body 10 as shown in FIG. 7. At this time, it is possible to rotate the camera unit 30 and the display panel 20 together due to the connection by the locking unit 70.

At this time, a user may photograph the image by using the manipulating keys 11a and the zoom knob 11b on the main body 10. That is, the user can grasp the main body 10 with one hand and photograph the image while seeing the images through the display panel 20.

If the user wants to change the photographing mode while photographing the image, e.g., if the user wants to photograph the still image instead of the motion image, or vice versa, the user unlocks the locking unit 70 and unfolds the camera unit 30 from the display panel 20 to a predetermined distance as shown in FIG. 1. Then, the user rotates the camera unit 30 at an angle of 180 degrees so that the camera portion 32 or 33 corresponding to the desired photographing mode is exposed outward, as shown in FIG. 4. Finally, the user locks the display panel 20 and the camera unit 30 again and photographs the image.

As discussed above, by forming the display panel 20 and the camera unit 30 in a foldable manner, its operation and structure is made more simple. Further, it is possible to obtain a compact design, slimness, and convenience required for a next-generation digital electronic product.

As shown in FIG. 4, the user may set a photographing mode to photograph the image while the camera unit 30 is unfolded from the display panel 20 and rotated at a predetermined angle on the second shaft 36. In this case, the user photographs the image from all angles in a natural manner without having to change his/her postures or hand positions.

As described above, according to the embodiment of the present invention, the image photographing apparatus is constructed as the folder type that allows rotating of the camera unit and the display panel while both are in a folded state together.

Hence, changing the operation of the photographing apparatus according to the changed position of the camera unit and the display panel becomes easy. Also, the size of the photographing apparatus is both compact and slim.

In addition, since the camera unit is rotated with respect to the two rotational axis, and independently from the display panel, the image can be photographed from all angles without being limited by the posture of the user.

While the present invention has been shown and described with reference to a certain embodiment, it would be appreciated by those skilled in the art that changes may be made in this embodiment without departing from the principles and spirit of the invention, the scope of which is defined in the claims and their equivalents.

1. A folder type image photographing apparatus comprising:
a main body at which a recording medium is mounted;
a display panel disposed at the main body and rotatable about a first axis to display a photographed image; and
a camera unit coaxially disposed with respect to the display panel and rotatable about the first axis, the camera unit being further rotatable about a second axis to select between a first and second camera.

2. An apparatus as claimed in claim 1, wherein the first axis is perpendicular to the second axis.

3. An apparatus as claimed in claim 1, further comprising a locking unit to removably secure the camera unit to the display panel.

4. An apparatus as claimed in claim 1, wherein the camera unit is rotatable about the second axis independent of the display panel.

5. An apparatus as claimed in claim 1, wherein:
the first camera is disposed on a first surface of the camera unit to capture motion images; and
the second camera is disposed on a second surface of the camera unit to capture still images.

6. A multifunction photographing apparatus comprising:
a camera unit rotatably disposed with respect to the photographing apparatus and rotatable about a first axis, the camera unit being further rotatable about a second axis to select between a first and second camera.

7. An apparatus as claimed in claim 6, wherein the first axis is substantially perpendicular to the second axis.

8. An apparatus as claimed in claim 6, wherein:
the first camera is disposed on a first surface of the camera unit to capture motion images; and
the second camera is disposed on a second surface of the camera unit to capture still images.

9. A method for providing a folder type image photographing apparatus for changing photographing modes while photographing an image, comprising the steps of:
providing a display panel and a camera unit to be rotatable about a first axis from an upper side of a main body of the image photographing apparatus;
providing a locking unit for allowing the display panel and the camera unit to be secured and rotatable together about the first axis; and
providing the camera unit to be rotatable about a second axis to select between a first and second camera.

10. A method as claimed in claim 9, further comprising changing photographing modes, comprising the steps of:
unlocking the locking unit and rotating the camera unit about the first axis from the display panel to a predetermined distance; and
rotating the camera unit about the second axis such that the first or second camera corresponding to a desired photographing mode is exposed.

11. A method as claimed in claim 10, wherein the first axis is perpendicular to the second axis.

12. A method as claimed in claim 10, wherein:
the first camera is disposed on a first surface of the camera unit to capture motion images; and
the second camera is disposed on a second surface of the camera unit to capture still images.

13. A method for changing photographing modes in a folder type image photographing apparatus, comprising the steps of:
rotating a camera unit about a first axis from the apparatus to a predetermined distance; and
rotating the camera unit about a second axis such that the first or second camera corresponding to a desired photographing mode is exposed.

14. A method as claimed in claim 13, wherein:
the first camera is disposed on a first surface of the camera unit to capture motion images; and
the second camera is disposed on a second surface of the camera unit to capture still images.

15. A method as claimed in claim 13, wherein the first axis is perpendicular to the second axis.
